(19) United States
(12) Patent Application Publication
(10) Pub. No.: US 2013/0207610 A1
(43) Pub. Date: Aug. 15, 2013

(54) BALANCING CELLS IN A BATTERY PACK

(71) Applicants: John HULL, Santa Clara, CA (US); Guoxing LI, Sunnyvale, CA (US); Constantin BUCUR, Santa Clara, CA (US)

(72) Inventors: John HULL, Santa Clara, CA (US); Guoxing LI, Sunnyvale, CA (US); Constantin BUCUR, Santa Clara, CA (US)

(21) Appl. No.: 13/585,158

(22) Filed: Aug. 14, 2012

Related U.S. Application Data
(60) Provisional application No. 61/530,751, filed on Sep. 2, 2011.

(51) Int. Cl. H02J 7/00

(52) U.S. Cl. CPC H02J 7/0063
USPC 320/118; 320/136

(57) ABSTRACT

A cell balancing system includes comparators coupled to battery cells. The K^{th} comparator of the comparators compares a cell voltage for the K^{th} battery cell of the battery cells with a reference threshold. A result of the comparison includes information useful for identifying a subset of the battery cells that have reached the reference threshold. The cell balancing system also includes a controlling logic circuit, coupled to the comparators, that selects a battery cell from the subset of the battery cells and turns on a corresponding switch to discharge the selected battery cell.

### RELATED APPLICATION

The present application claims priority to the U.S. provisional application filed on Sep. 2, 2011, Ser. No. 61/530,751, hereby incorporated by reference in its entirety.

### BACKGROUND

FIG. 1 shows a block diagram of a conventional cell balancing system 100. As shown in FIG. 1, a battery pack includes multiple battery cells 106_1-106_N coupled in series. Each of the resistors 102_1-102_N is coupled between two terminals of a corresponding cell of the battery cells 106_1-106_N via a corresponding switch of the switches 104_1-104_N. An analog multiplexer 110 includes multiple switches 108_1-108_N. A terminal of the switch 108_K is coupled to the positive terminal of the battery cell 106_K (K=1, 2, . . . , N), and another terminal of the switch 108_K is coupled to an analog to digital (A/D) converter 112. The ND converter 112 is coupled to a microprocessor 114.

The microprocessor 114 controls the switches 104_1-104_N for cell balancing. The microprocessor 114 also controls the analog multiplexer 110 for channel selection, e.g., it selects positive terminals of the battery cells 106_1-106_N by turning on the switches 108_1-108_N. The ND converter 112 receives terminal voltages at those positive terminals of the selected battery cells and generates corresponding digital information. The microprocessor 114 reads the digital information from the ND converter 112, calculates the cell voltages of the battery cells 106 _1-106 _N according to the digital information, and compares the cell voltages with a predetermined level denoting a specific state of charge to determine the states of the battery cells 106_1-106_N. The microprocessor 114 also determines the voltage differences between the cell voltages and compares the voltage differences with a reference level to ascertain if there is a need to balance the battery pack. By way of example, the microprocessor 114 determines which cell of the battery cells 106_1-106_N has the highest voltage, and turns on a corresponding switch of the switches 104_1-104_N to bleed off charge from that cell. Thus, the cells in the battery pack can be balanced. However, the above method is a resource-intensive process that requires an ND converter 112 to convert the cell voltages to digital signals, and a microprocessor 114 to read the digital signals and make a determination of which cells to balance and when. This method is relatively complex and expensive to implement.

### SUMMARY

In one embodiment, a cell balancing system includes comparators coupled to battery cells. The K^{th} comparator compares a cell voltage for the K^{th} battery cell with a reference threshold. A result of the comparison includes information useful for identifying a subset of the battery cells that have reached the reference threshold. The cell balancing system also includes a controlling logic circuit, coupled to the comparators, that selects a battery cell from the subset of the battery cells and turns on a corresponding switch to discharge the selected battery cell.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a block diagram of a conventional cell balancing system.

FIG. 2 shows a block diagram of an example of a cell balancing system in an embodiment according to the present invention.

FIG. 3 shows examples of plots for cell voltages associated with the cell balancing system in FIG. 2 in an embodiment according to the present invention.

FIG. 4 shows a flowchart of examples of operations performed by a cell balancing system in an embodiment according to the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

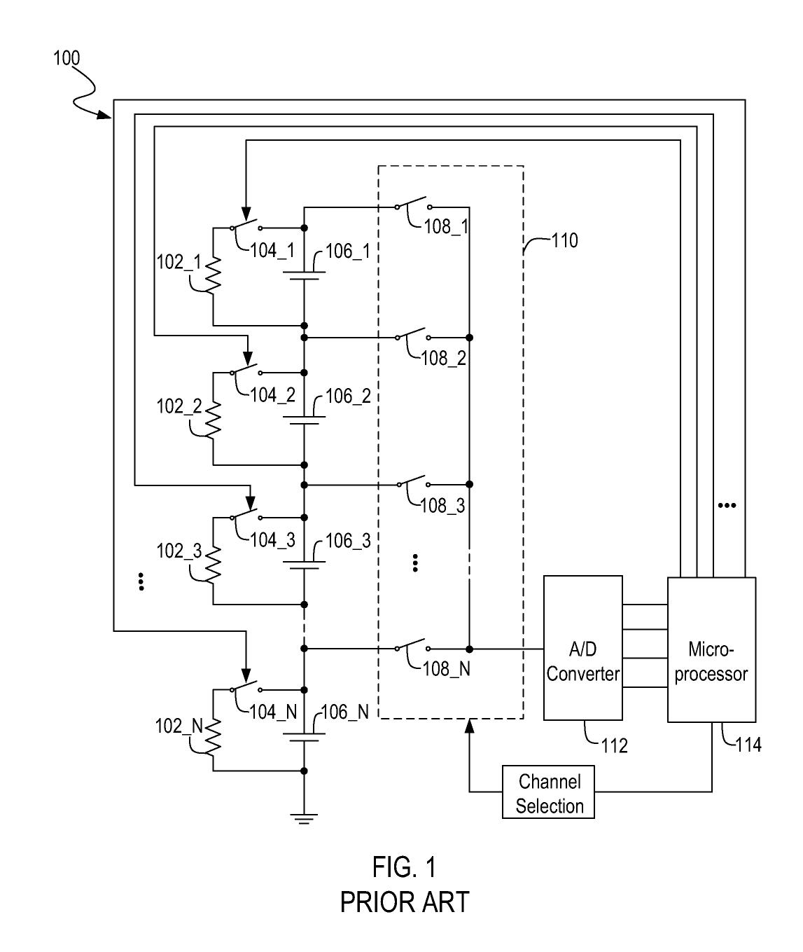

In one embodiment, a cell balancing system includes multiple comparators for making a measurement of battery cells. Each of the comparators compares a cell voltage of a cell of the battery cells with a reference threshold and generates comparison information. The cell balancing system also includes a controlling logic circuit for controlling multiple switches coupled to the battery cells, so that the battery cells can reach substantially the same voltage. By way of example, the controlling logic circuit selects a cell of the battery cells that reaches the reference threshold based on the comparison information, and turns on a corresponding switch to discharge the selected cell. Thus, the battery pack can achieve a balance condition. Advantageously, compared with the conventional cell balancing system in FIG. 1, a cell balancing system according to the present invention has a simpler circuit structure, and therefore a cell balancing process according to the present invention can be simplified and implemented less expensively.

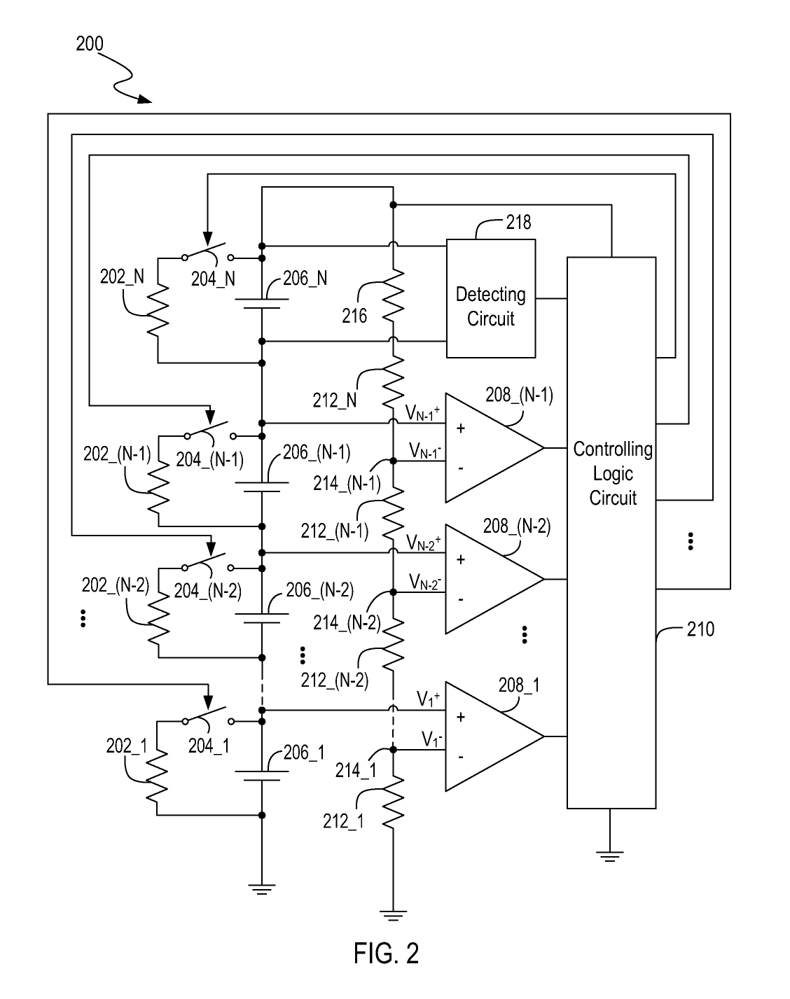

FIG. 2 shows a block diagram of an example of a cell balancing system 200 in an embodiment according to the present invention. The system 200 can balance series-coupled battery cells 206_1-206_N by discharging a battery cell that reaches a reference threshold while a charging current is applied. N is a positive integer. The battery cells 206_1-206_N can be, but are not limited to, Lithium-ion battery cells, Lead-acid battery cells, or NiMH battery cells.

As shown in FIG. 2, a battery pack includes multiple battery cells 206_1-206_N coupled in series. In one embodiment, the cell balancing system 200 includes multiple discharging paths coupled to the battery cells 206_1-206_N, and each discharging path includes a load resistor 202_1-202_N and a switch 204_1-204_N. The cell balancing system 200 also includes reference resistors 212_1-212_N, a detecting circuit 218, comparators 208_1-208_M (M=N−1), and a controlling logic circuit 210. The K^{th} discharging path including the K^{th} load resistor 202_K and the K^{th} switch 204_K is coupled in parallel to the K^{th} battery cell 206_K (K=1, 2, . . . , N). For example, the load resistor 202_1 is coupled between two terminals of the battery cell 206_1 via the switch 204_1. The detecting circuit 218 is coupled to two terminals of the battery cell 206_N. Non-inverting input terminals of the comparators 208_1-208_M (M=N−1) are coupled to positive terminals of the battery cells 206_1-206_M (M=N−1), respectively. Inverting input terminals of the comparators 208_1-208_M (M=N−1) are coupled to common nodes 214_1-214_M (M=N−1) between the reference resistors 212_1-212_N, respectively. Output terminals of the detecting circuit 218 and the comparators 208_1-208_M (M=N−1) are coupled to the controlling logic circuit 210.

In one embodiment, the reference resistors 212_1-212_N are coupled to each other in series and have substantially the same impedance. Therefore, the respective voltages V₂₁₂_{_{—}}₁, V₂₁₂_{_{—}}₂, . . . , V₂₁₂_{_{—}}_{N} across the reference resistors 212_1-212_N are substantially the same, e.g., V₂₁₂_{_{—}}₁=V₂₁₂_{_{—}}₂= . . . =V₂₁₂_{_{—}}_{N}=V_{TH}. The level of the voltages V₂₁₂_{_{—}}₁, V₂₁₂_{_{—}}₂, . . . , V₂₁₂_{_{—}}_{M} across the reference resistors 212 _1-212 _M (M=N−1) can be referred to as a reference threshold V_{TH} (or a balance threshold). That is, the reference resistors 212_1-212_N can be used to provide M reference thresholds V_{TH}. The reference thresholds V_{TH} correspond to the voltages V₂₁₂_{_{—}}₁, V₂₁₂_{_{—}}₂, . . . , V₂₁₂_{_{—}}_{M} across the reference resistors 212_1-212_M (M=M−1). In other words, each reference threshold V_{TH} corresponds to a voltage across a reference resistor of the reference resistors 212_1-212_M. As used herein, “substantially the same impedance” means that a difference between the impedances of the reference resistors 212_1-212_N is permissible so long as the difference is relatively small and can be ignored. As used herein, “voltages across the reference resistors are substantially the same” means that a difference between the voltages across the reference resistors 212_1-212_N may exist due to non-ideality of the reference resistors 212_1-212_N but the difference is relatively small and can be ignored.

In one embodiment, the K^{th} comparator 208_K (K=1, 2, . . . , N−1) compares the cell voltage V₂₀₆_{_{—}}_{K} of the K^{th} battery cell 206_K with the K^{th} reference threshold V_{TH}, e.g., the voltage V₂₁₂_{_{—}}_{K} across the K^{th} reference resistor 212_K, by comparing a voltage at a positive terminal of the K^{th} cell 206_K with a voltage at a node 214_K between the K^{th} and K+1^{th} reference resistors 212_K and 212_(K+1). More specifically, the K^{th} comparator 208_K compares the voltage V_{K}⁺ (K=1, 2, . . . , N−1) of its non-inverting input terminal with the voltage V_{K}⁻ (K=1, 2, . . . , N−1) of its inverting input terminal. The voltage V_{K}⁺ of the non-inverting input terminal of the K^{th} comparator 208_K, e.g., the voltage at the positive terminal of the K^{th} cell 206_K, is equal to the sum of cell voltages V₂₀₆_{_{—}}₁, V₂₀₆_{_{—}}₂, . . . , V₂₀₆_{_{—}}_{K} of the corresponding cells 206_1-206_K, e.g., V_{K}⁺=V₂₀₆_{_{—}}₁+ . . . +V₂₀₆_{_{—}}_{K}. The voltage V_{K}⁻ of the inverting input terminal of the K^{th} comparator 208_K, e.g., the voltage at the node 214_K between the reference resistors 212_K and 212_(K+1), is equal to the sum of voltages across corresponding reference resistors 212_1-212_K, e.g., V_{K}⁻=V₂₁₂_{_{—}}₁+ . . . +V₂₁₂_{_{—}}_{K}=K*V_{TH}. In one embodiment, a difference between the voltage V₂₀₆_{_{—}}₁+ . . . +V₂₀₆_{_{—}}_{(K-1)} across the series-coupled cells 206_1-206_(K−1) and the voltage V₂₁₂_{_{—}}₁+ . . . +V₂₁₂_{_{—}}_{(K-1)} across the series-coupled reference resistors 212_1-212_(K−1) is within a relatively small range, and therefore the difference between the voltage V₂₀₆_{_{—}}₁+ . . . +V₂₀₆_{_{—}}_{K} across the series-coupled cells 206_1-206_K and the voltage V₂₁₂_{_{—}}₁+ . . . +V₂₁₂_{_{—}}_{K} across the series-coupled reference resistors 212_1-212_K represents the difference between the cell voltage V₂₀₆_{_{—}}_{K} of the cell 206_K and the voltage V₂₁₂_{_{—}}_{K} across the reference resistor 212_K. In other words, a result of a comparison between the sum of the cell voltages of the cells 206_1-206_K and the sum of the voltages across the reference resistors 212_1-212_K, e.g., a result of a comparison between the voltage at the positive terminal of the cell 206_K and the voltage at the node 214_K, represents a result of a comparison between the cell voltage of the cell 206_K and the voltage across the reference resistor 212_K, e.g., the reference threshold V_{TH}. If the voltage at the positive terminal of the cell 206_K is greater than the voltage at the node 214_K, e.g., if the cell voltage of the cell 206_K is greater than the reference threshold V_{TH}, then the comparator 208_K outputs a logic high signal to the controlling logic circuit 210. The result of the comparison includes information, e.g., a logic high signal or logic low signal, useful for identifying a subset of the battery cells 206_1-206_M (M=N−1) that have reached the reference threshold V_{TH}—e.g., that have reached the corresponding subset of the voltages V₂₁₂_{_{—}}₁, V₂₁₂_{_{—}}₂, . . . , V₂₁₂_{_{—}}_{M} across the reference resistors 212_1-212_M. The subset of the battery cells 206_1-206_M (M=N−1) includes one or more battery cells.

Additionally, the detecting circuit 218 with a reference threshold V′_{TH} is used to detect the voltage of the battery cell 206_N. The reference threshold V^{′}_{TH} can be equal to or slightly greater than the reference threshold V_{TH} mentioned above. Similar to the comparators 208_1-208_M (M=N−1), if the voltage of the battery cell 206_N is greater than the reference threshold V^{′}_{TH}, then the detecting circuit 218 generates a control signal, e.g., a logic high signal, to the controlling logic circuit 210, such that the controlling logic circuit 210 turns on the corresponding switch 204_N to discharge the battery cell 206_N for a period of time. The battery cell 206_N is discharged through the load resistor 202_N and the voltage of the battery cell 206_N decreases.

In one embodiment, if a subset of the battery cells 206_1-206_M (where a subset includes one or more battery cells) have reached the reference threshold V_{TH}, then a corresponding subset of the comparators 208_1-208_M (M=N−1) can output logic high signals in parallel. In one such embodiment, the controlling logic circuit 210 randomly selects a battery cell from the subset of the battery cells 206_1-206_M, and turns on the corresponding switch 204_1-204_M to discharge the selected battery cell.

In one embodiment, the cell balancing system 200 alternates between a measure mode and a balance mode. By way of example, the cell balancing system 200 includes timer circuitry (not shown). When the cell balancing system 200 enters the measure mode, the timer circuitry starts to measure time. The cell balancing system 200 operates in the measure mode for a first predetermined duration (hereinafter, measure duration). When the measure duration is expired, the timer circuitry generates a trigger signal and restarts to measure time. In response to the trigger signal, the cell balancing system 200 enters the balance mode. The cell balancing system 200 operates in the balance mode for a second predetermined duration (hereinafter, balance duration). When the balance duration is expired, the timer circuitry generates another trigger signal and restarts to measure time. In response to this trigger signal, the cell balancing system 200 enters the measure mode again.

In operation, in one embodiment, the cell balancing system 200 operates for the measure duration and the balance duration alternately. In the measure duration, the comparators 208_1-208_M (M=N−1) compare the cell voltages of battery cells 206_1-206_M (M=N−1) with the reference thresholds V_{TH}, e.g., the voltages V₂₁₂_{_{—}}₁, V₂₁₂_{_{—}}₂, . . . , V₂₁₂_{_{—}}_{M}, provided by the reference resistors 212_1-212_N, e.g., by comparing the voltages at the positive terminals of the battery cells 206_1-206_M (M=N−1) with the voltages at the common nodes 214_1-214_M (M=N−1) respectively. In addition, the controlling logic circuit 210 receives the output signals from the comparators 208_1-208_M (M=N−1) and identifies a comparator in the comparators 208_1-208_M (M=N−1) that first outputs a logic high signal, so as to identify a battery cell in the battery cells 206_1-206_M (M=N−1) that first reaches the reference threshold V_{TH}. If the cell 206_{—}f (f=1, 2, . . . , N−1), relative to the other cells of the battery cells 206_1-206_M (M=N−1), first reaches the reference threshold V_{TH}—e.g., if the comparator 208_{—}f (f=1, 2, . . . , N−1), relative to the other comparators of the comparators 208_1-208_M (M=N−1), first outputs a logic high signal—then the cell 206_{—}f is selected to be discharged for a predefined period of time by turning on the corresponding switch 204_{—}f during the balance duration following the measure duration. In the balance duration, the cell 206_{—}f is discharged through the load resistor 202_{—}f and the voltage of the cell 206_{—}f decreases. In the measure duration, the detecting circuit 218 also detects the status of the battery cell 206_N, and generates a control signal to the controlling logic circuit 210 if the cell voltage of the battery cell 206_N exceeds the reference threshold V′_{TH}. In response to the control signal, the controlling logic circuit 210 turns on the switch 204_N to discharge the battery 206_N in the balance duration.

When the balance duration is expired, the cell balancing system 200 enters a new measure duration, and the switch 204_{—}f (f=1, 2, . . . , N−1) and/or the switch 204_N are turned off. By operating in the measure duration and the balance duration alternately, the battery cells 206_1-206_N can reach substantially the same voltage, and the battery pack can achieve a balance condition. As used herein, “substantially the same” means that a difference between the voltages of the battery cells 206 _{—} 1-206 _N is permissible so long as the difference is relatively small and can be ignored.

In operation in another embodiment, in the measure duration, the controlling logic circuit 210 receives the output signals from the comparators 208_1-208_M (M=N−1) and determines which comparator outputs a logic high signal at the end of the measure duration, e.g., to determine which battery cell 206_1-206_M (M=N−1) has a cell voltage greater than the reference threshold V_{TH} at the end of the measure duration. In the measure duration, the controlling logic circuit 210 also receives the output signal from the detecting circuit 218, and determines whether the cell voltage of the battery cell 206_N is greater than the reference threshold V′_{TH} at the end of the measure duration.

At the end of the measure duration, the controlling logic circuit 210 identifies a subset of the battery cells 206_1-206_M that have reached the reference threshold V_{TH}. If the subset of the battery cells 206_1-206_M includes only one battery cell—e.g., if the cell voltage of a battery cell 206_{—}a (a=1, 2, . . . , N−1) is greater than the reference threshold V_{TH} and the voltages of the rest of the battery cells 206_1-206_(N−1) are not greater than the reference threshold V_{TH}, then the battery cell 206_{—}a is selected to be discharged during the balance duration following the measure duration. If the subset of the battery cells 206_1-206_M includes multiple battery cells—e.g., if cell voltages of two or more battery cells are greater than the reference threshold V_{TH}—then one battery cell in the multiple battery cells is, in one embodiment, randomly chosen to be discharged during the balance duration; however, other means may be used to select a battery cell to be discharged. Additionally, if the cell voltage of the battery cell 206_N is greater than the reference threshold V′_{TH}, the battery cell 206_N can be discharged during the balance duration. By operating in the measure duration and the balance duration alternately, the battery cells 206_1-206_N can have substantially the same cell voltage, e.g., the battery pack including the battery cells 206_1-206_N is balanced.

Furthermore, in one embodiment, the balancing process mentioned above is also suited to the battery cells when the battery cells are discharging, e.g., the balancing process when charging the battery cells is similar to the balancing process when discharging the battery cells.

In one embodiment, the reference threshold V_{TH} increases if an average level V_{AVE} of the cell voltages of the battery cells 206_1-206_N increases, or decreases if the average level V_{AVE} decreases. Moreover, the reference threshold V_{TH} can be less than the average level V_{AVE} of the battery voltages. By way of example, the reference resistors 212_1-212_N receive power from the battery cells 206_1-206_N through a resistor 216. Thus, the voltages across the reference resistors 212_1-212_N increase as the average level V_{AVE} of the battery voltages increases, or decrease as the average level V_{AVE} decreases, and the voltage across each reference resistor 212_1-212_N, e.g., the reference threshold V_{TH}, is less than the average level V_{AVE} of the battery voltages. Advantageously, since the reference threshold V_{TH} is less than the average level V_{AVE} of the battery voltages, the cell balancing system can start the balancing process at an early stage. Furthermore, since the reference threshold V_{TH} can vary as the average level V_{AVE} of the cell voltages of the battery cells 206_1-206_N varies, the balancing process of the battery cells 206_1-206_N is more stable.

Although, in the example of FIG. 2, the series-coupled reference resistors 212_1-212_N are disclosed to provide the reference threshold V_{TH}, the invention is not so limited. The reference threshold V_{TH} can also be provided by other methods.

Advantageously, a balanced condition does not need to be determined or established since this operation is a self-regulating process. Furthermore, the circuit structure of the cell balancing system 200 is simpler compared with that of the conventional cell balancing system 100. Due to its simpler circuit structure, the cell balancing process can be implemented less expensively and more easily.

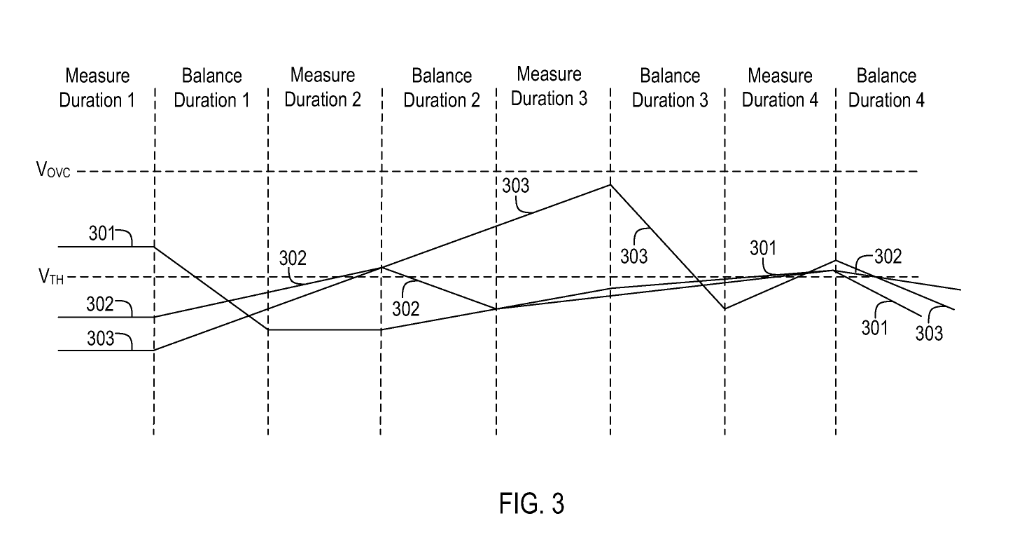

FIG. 3 shows examples of plots for cell voltages associated with the cell balancing system 200 in FIG. 2 in an embodiment according to the present invention. FIG. 3 is described in combination with FIG. 2. In the example of FIG. 3, the number of battery cells is set to 4. For example, a battery pack includes battery cells 206_1-206_4 coupled in series. However, the battery pack may include some other number of battery cells. In one embodiment, as described in relation to FIG. 2, the cell voltage of the battery cell 206_4 is detected by the detecting circuit 218 and is controlled by the controlling logic circuit 210 according to the detecting result. In addition, a cell voltage 301 of the battery cell 206_1, a cell voltage 302 of the battery cell 206_2, and a cell voltage 303 of the battery cell 206_3 are compared with a reference threshold V_{TH}.

In one embodiment, the reference threshold V_{TH} is provided by a set of series-coupled reference resistors, e.g., the reference resistors 212_1-212_4 in FIG. 2, and the reference threshold V_{TH} increases as the average level V_{AVE} of the voltages of the battery cells 206_1-206_4 increases. In another embodiment, the reference threshold V_{TH} can be equal to an overcharge voltage V_{OVC}, e.g., 4.4V, of the battery cells 206_1-206_4. In yet another embodiment, the reference threshold V_{TH} is some level, e.g., 4.3V, below the overcharge threshold V_{OVC}.

In one embodiment, the controlling logic circuit 210 detects the status of the battery cells during each measure duration. In the example of FIG. 3, in measure duration 1, the battery cell 206_1 with the cell voltage 301 is the only cell that reaches the reference threshold V_{TH}, and therefore the battery cell 206_1 is selected to be discharged during balance duration 1. In measure duration 2, although the cell voltages for multiple cells reach the reference threshold, the battery cell 206_2 with the cell voltage 302 is the cell that first reaches the reference threshold V_{TH}, and therefore the battery cell 206_2 is selected to be discharged during balance duration 2. In measure duration 3, the battery cell 206_3 with the cell voltage 303 is the only cell that reaches the reference threshold V_{TH}, and therefore the battery cell 206_3 is selected to be discharged during balance duration 3. In measure duration 4, although the cell voltages for multiple cells reach the reference threshold, the battery cell 206_1 with the cell voltage 301 is the cell that first reaches the reference threshold V_{TH} in measure duration 4, and therefore the battery cell 206_1 is selected to be discharged during balance duration 4.

In another embodiment, the controlling logic circuit 210 detects the status of the battery cells at the end of each measure duration. In the example of FIG. 3, at the end of measure duration 1, the cell voltage 301 of the battery cell 206_1 is greater than the reference threshold V_{TH}, and therefore the battery cell 206_1 is selected to be discharged during balance duration 1. At the end of measure duration 2, the cell voltage 302 of the battery cell 206_2 and the cell voltage 303 of the battery cell 206_3 are both greater than the reference threshold V_{TH}. In one embodiment, the battery cell 206_2 is randomly selected to be discharged during balance duration 2; other means may be used to select a battery cell to be discharged. At the end of measure duration 3, the cell voltage 303 is greater than the reference threshold V_{TH}, and therefore the battery cell 206_3 is selected to be discharged during balance duration 3. At the end of measure duration 4, the cell voltages 301, 302 and 303 are greater than the reference threshold V_{TH}. In one embodiment, the battery cell 206_1 is randomly selected to be discharged during balance duration 4, although other means may be used to select a battery cell to be discharged.

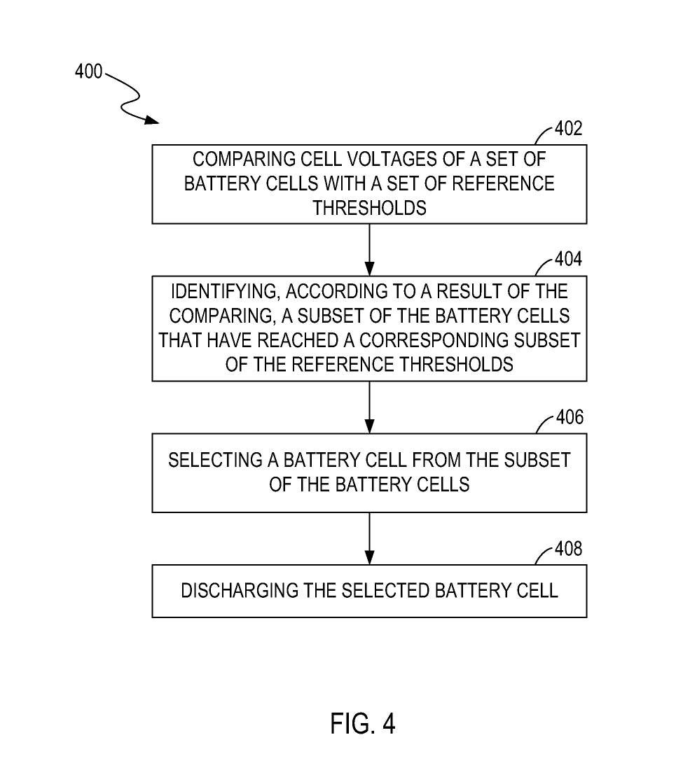

FIG. 4 shows a flowchart of examples of operations performed by the cell balancing system 200 in FIG. 2 in an embodiment according to the present invention. FIG. 4 is described in combination with FIG. 2. Although specific steps are disclosed in FIG. 4, such steps are examples. That is, the present invention is well suited to performing various other steps or variations of the steps recited in FIG. 4.

In block 402, comparator circuitry, e.g., including the comparators 208_1-208_M, compares the cell voltages of the battery cells 206_1-206_M with reference thresholds V_{TH}, e.g., the voltages V₂₁₂_{_{—}}₁, V₂₁₂_{_{—}}₂, . . . V₂₁₂_{_{—}}_{M} across the reference resistors 212_1-212_M. More specifically, the cell voltage of the K^{th} battery cell is compared with the K^{th} reference threshold V_{TH}, e.g., the voltage V₂₁₂_{_{—}}_{K} across the reference resistor 212_K (K=1, 2, . . . , M).

In block 404, the controlling logic circuit 210 identifies a subset (including one or more battery cells) of the battery cells 206_1-206_M that have reached a corresponding subset of the reference thresholds V_{TH}. By way of example, if the controlling logic circuit 210 detects that the battery cell 206_2 has reached the voltage V₂₁₂_{_{—}}₂ across the reference resistor 212_2, and the battery cell 206_4 has reached the voltage V₂₁₂_{_{—}}₄ across the reference resistor 212_4, then the controlling logic circuit 210 identifies the subset that includes the battery cells 206_2 and 206_4.

In block 406, the controlling logic circuit 210 selects a battery cell from the identified subset of the battery cells 206_1-206_M. In one embodiment, the controlling logic circuit 210 selects the battery cell in the battery cells 206_1-206_M that first reaches the reference threshold V_{TH}. In another embodiment, the controlling logic circuit 210 randomly selects a battery cell from the battery cells in the subset.

In block 408, the controlling logic circuit 210 can turn on a corresponding switch 204_1-204_M to discharge the selected battery cell.

In summary, embodiments according to the present invention provide cell balancing systems. In one embodiment, a cell balancing system includes multiple comparators for making a measurement of battery cells by comparing cell voltages with a reference threshold. The cell balancing system also includes a controlling logic circuit for controlling multiple switches coupled to the battery cells, so that all the battery cells can reach substantially the same voltage. By way of example, the controlling logic circuit turns on a corresponding switch to discharge a battery cell that reaches the reference threshold. The cell balancing system operates in a measure duration and a balance duration alternately. In this way, the battery cells can reach substantially the same voltage, and the battery pack can achieve a balance condition. Advantageously, a determination of a balanced condition is not needed since this operation is a self-regulating process. Furthermore, compared with the conventional cell balancing system in FIG. 1, a cell balancing system according to the present invention has a simpler circuit structure, and therefore is simplified and implemented less expensively.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A cell balancing system comprising:
a plurality of comparators coupled to a plurality of battery cells, wherein the K^{th} comparator of said comparators compares a cell voltage for the K^{th} battery cell of said battery cells with a reference threshold, wherein K is a positive integer and wherein a result of the comparison comprises information useful for identifying a subset of said battery cells that have reached said reference threshold; and
a controlling logic circuit, coupled to said comparators, operable for selecting a battery cell from said subset and for turning on a corresponding switch to discharge the selected battery cell.

2. The cell balancing system as claimed in claim 1, wherein said battery cells are coupled to each other in series.

3. The cell balancing system as claimed in claim 1, further comprising:
a plurality of resistive elements coupled to each other in series and coupled to said comparators, and having substantially the same impedance.

4. The cell balancing system as claimed in claim 3, wherein voltages across said resistive elements are substantially the same, and wherein said reference threshold corresponds to a voltage across a resistive element of said resistive elements.

5. The cell balancing system as claimed in claim 3, wherein said K^{th} comparator compares said cell voltage for said K^{th} battery cell with said reference threshold by comparing a voltage at a terminal of said K^{th} battery cell with a voltage at a node between a pair of said resistive elements.

6. The cell balancing system as claimed in claim 1, wherein said reference threshold increases if an average level of cell voltages of said battery cells increases, and decreases if said average level decreases.

7. The cell balancing system as claimed in claim 1, wherein said controlling logic circuit identifies a battery cell in said battery cells that first reaches said reference threshold, and wherein said battery cell selected from said subset is said battery cell that first reaches said reference threshold.

8. The cell balancing system as claimed in claim 1, wherein said subset comprises multiple battery cells, and wherein said battery cell selected from said subset is chosen from said multiple battery cells randomly.

9. A method for balancing battery cells in a battery pack, said method comprising:
comparing, using comparator circuitry, a plurality of cell voltages of said battery cells with a plurality of reference thresholds, wherein a cell voltage for the K^{th} battery cell is compared with the K^{th} reference threshold, wherein K is a positive integer;
identifying, according to a result of said comparing, a subset of said battery cells that have reached a corresponding subset of said reference thresholds;
selecting, using a controlling logic circuit, a battery cell from said subset of said battery cells; and
discharging the selected battery cell.

10. The method as claimed in claim 9, further comprising:
providing said reference thresholds using a plurality of resistive elements, wherein said reference thresholds correspond to voltages across said resistive elements.

11. The method as claimed in claim 9, further comprising:
providing said reference thresholds using a plurality of resistive elements coupled to each other in series, wherein said resistive elements have substantially the same impedance.

12. The method as claimed in claim 11, further comprising:
supplying power to said resistive elements using said battery cells.

13. The method as claimed in claim 9, wherein said selecting comprises identifying a battery cell in said battery cells that first reaches a corresponding reference threshold, and wherein said battery cell selected from said subset of said battery cells is said battery cell that first reaches said corresponding reference threshold.

14. The method as claimed in claim 9, wherein said subset of said battery cells comprises multiple battery cells, and wherein said selecting comprises selecting said battery cell from said multiple battery cells randomly.

15. A cell balancing circuit comprising:
a plurality of discharging paths comprising M discharging paths and coupled to a plurality of battery cells comprising M battery cells, wherein the K^{th} discharging path of said discharging paths is coupled in parallel to the K^{th} battery cell of said battery cells, and wherein M is a positive integer and K=1, 2, . . . , M; and
a controlling unit, coupled to said discharging paths, operable for comparing a plurality of cell voltages of said battery cells with a plurality of reference thresholds comprising M reference thresholds, a cell voltage for the K^{th} battery cell being compared with the K^{th} reference threshold, said controlling unit operable for using a result of said comparing to identify a subset of said battery cells that have reached a corresponding subset of said reference thresholds, and operable for selecting a battery cell from said subset of said battery cells and turning on a corresponding discharging path to discharge the selected battery cell.

16. The cell balancing circuit as claimed in claim 15, wherein said controlling unit identifies a battery cell in said battery cells that first reaches a corresponding reference threshold, and wherein said battery cell selected from said subset of said battery cells is said battery cell that first reaches said corresponding reference threshold.

17. The cell balancing circuit as claimed in claim 15, wherein said subset of said battery cells comprises multiple battery cells, and wherein said battery cell selected from said subset of said battery cells is chosen from said multiple battery cells randomly.

18. The cell balancing system as claimed in claim 15, further comprising:
a plurality of resistive elements coupled to each other in series, wherein said resistive elements are powered by said battery cells to provide said reference thresholds.

19. The cell balancing system as claimed in claim 15, further comprising:
a plurality of resistive elements, coupled to each other in series, having substantially the same impedance, and operable for providing said reference thresholds.

20. The cell balancing system as claimed in claim 15, wherein said reference thresholds increase if an average level of cell voltages of said battery cells increases, and decrease if said average level decreases.
